(19) United States
(12) Patent Application Publication
(10) Pub. No.: US 2017/0348683 A1
(43) Pub. Date: Dec. 7, 2017

(54) METHOD FOR FORMING CATALYTIC NANOCOATING

(71) Applicant: TEKNOLOGIAN TUTKIMUSKESKUS VTT OY, Espoo (FI)

(72) Inventors: Pekka SIMELL, VTT (FI); Johanna KIHLMAN, VTT (FI); Matti REINIKAINEN, VTT (FI); Jorma JOKINIEMI, VTT (FI); Anna LÄHDE, Havumittari (FI)

(73) Assignee: TEKNOLOGIAN TUTKIMUSKESKUS VTT OY, Espoo (FI)

(21) Appl. No.: 15/541,205

(22) PCT Filed: Dec. 8, 2015
(86) PCT No.: PCT/FI2015/050863

§ 371 Date: Jun. 30, 2017

(30) Foreign Application Priority Data
Dec. 31, 2014 (FI) 20146177

(51) Int. Cl. B01J 37/02; B01J 35/00; B01J 35/02; B01J 37/34

(52) U.S. Cl. CPC B01J 37/0225; B01J 37/349; B01J 37/0238; B01J 37/0232; B01J 35/0013; B01J 37/0217; B01J 35/023; B01J 37/0228

(57) ABSTRACT

Provided is a method for forming catalytic nanocoating on a metal surface. The method comprises pretreating the metal surface by means of heat treatment at 500-800° C., forming a metaloxide support, and depositing catalytic nanosized metal and/or metaloxide particles on the metaloxide support and coating the metal surface with catalytic nanosized metal and/or metaloxide particles. Further, the invention relates to a catalyst and a use.

### FIELD OF THE INVENTION

The invention relates to a method defined in the preamble of claim 1 for forming a catalytic nanocoating. Further, the invention relates to a catalyst defined in the preamble of claim 11 and a use defined in the preamble of claim 13.

### BACKGROUND OF THE INVENTION

Different methods for preparing catalysts are known from the prior art. In the art there are several types of catalysts which differ tooth in structure and materials. One specific type of catalyst consists of a metal substrate on which a catalytically active layer has been deposited.

Several methods for the deposition of the active layer are known from the prior art. Typically, the catalytically active layer is added to the metal substrate by washcoating using alumina or another metal oxide slurry containing the catalytically active metals in the form of salts, oxides or elemental metals. Substrates can also be first washcoated with a metal oxide slurry, and then a catalyst metal addition can be performed using traditional methods, such as impregnation. In these methods it is difficult to control the size of the metal particles, dispersion, or the thickness of the layer. Thus, excessively high metal loadings have to be used in order to obtain high catalytic activity. It is beneficial to decrease the metal loading in catalytic reactors, for instance,, due to the fact that catalytically active metals are in many cases getting more and more expensive and many of them are rare and strategic metals.

Further, from the prior art is known a flame spray pyrolysis (FSP) method for forming different particles.

### OBJECTIVE OF THE INVENTION

The objective of the invention is to disclose a new type method for forming catalytic nanocoating. Further, the objective of the invention is to disclose a method for forming a new type catalyst.

### SUMMARY OF THE INVENTION

The method according to the invention is characterized by what has been presented in the claims.

The invention is based on a method for forming a catalytic nanocoating on a metal surface of a metal object. The method comprises: pretreating the metal surface by means of heat treatment at 500-800° C., forming a metaloxide, support, e.g. Al₂O₃ support, and depositing catalytic nanosized metal and/or metaloxide particles on the metaloxide support and coating the metal surface with catalytic nanosized metal and/or metaloxide particles. Preferably, there is utilized a flame spray pyrolysis (FSP) method in the forming of the particles, e.g. in the forming of the metaloxide support or in the coating of the metal surface.

In the invention, a metal surface is pretreated and a catalytic nanocoating of catalytically active metals and/or metaloxides is formed on the metal surface. In the invention, the catalytic nanocoating can be arranged directly onto the metal surface. The structure of the surface can be modified when the metal surface is pretreated at high temperature. Then the catalytic nanocoating on the metal surface is permanent and durable.

Further, the invention is based on a catalyst which comprises a catalytic nanocoating, preferably a catalyst layer, on the metal surface, and the catalytic nanocoating has been formed onto the metal surface according to the method presented in this context. The catalytic nanocoating is a catalytically active coating.

Any flame spray pyrolysis (FSP) method which is suitable for forming particles, e.g. nanosized particles or nanoparticles, and which is known per se can be used in the method of the present invention. In the flame spray pyrolysis (FSB) method typically various oxide powders are produced by introducing organic liquid fuel, e.g. ethanol, toluene, hexane or the like, into a supporting methane flame, which then ignites the introduced fuel making the flame. Organometallic precursors are dissolved in the fuel and in the flame they decompose and form small metaloxide particles, preferably nanosized particles. Typically various metaloxide powders are manufactured by FSP method. One embodiment of flame spray pyrolysis (FSP) is presented in FIG. 3.

Any chemical vapour synthesis (CVS) method which is suitable for forming nanosized particles or nanoparticles and which is known per se can be used in the method of the present invention. The chemical vapour synthesis (CVS) method is a modified chemical vapour deposition (CVD) method where the process parameters are adjusted to form nanoparticles instead of film. In CVS, precursors are metalorganics, carbonyls, hydrides, chlorides and other volatile compounds in gaseous, liquid or solid state. Chemical vapour reaction, chemical vapour condensation and chemical vapour precipitation are synonyms used frequently in the literature

In this context, a metaloxide support may comprise any metaloxide or any mixture of different metaloxides. Further, the metaloxide support may comprise other components, e.g. suitable binder and/or filler agent. In one embodiment, the metaloxide support is formed from metaloxide or metaloxides selected from the group consisting of Al₂O₃, MgO, TiO₂, other suitable metaloxide and their combinations. In one embodiment, the metaloxide support is Al₂O₃ support which comprises Al₂O₃.

In this context, a catalytic nanosized metal particle and/or metaloxide particle may comprise any suitable metal which is catalytically active metal. In one embodiment, metal is selected from the group consisting of Co, Ni, Mo, Zr, Ti, Hf, noble metal, other suitable metal and their combinations.

In this context, a metal object may be any metal object, for example metal article, metal plate, metal film, metal sheet, metal particle, metal piece, or the like.

In one embodiment, the metal surface is heat-treated by oxidizing, preferably at temperatures between 500-800° C.

In one embodiment, the metaloxide support, e.g. Al₂O₃ support, is formed by washcoating on the metal surface. In one embodiment, the metal surface is washcoated with a metaloxide based, slurry, e.g. Al₂O₃ based slurry. In one embodiment, the washcoating is carried out by spraying. In one embodiment, the washcoating is carried out by dip-coating. Alternatively, the washcoating can be carried out by other suitable method. In one embodiment, the metaloxide support formed by washcoating is calcined at 400-800° C. In one embodiment, catalytic nanosized metal particles and/or metaloxide particles, e.g. Co metaloxide particles, are deposited by means of a flame spray pyrolysis (FSP) method on the metal surface which has been coated with the metaloxide support, e.g. Al₂O₃ support.

In one embodiment, the metal surface is pretreated by means of heat treatment at 500-800° C., the metaloxide support is formed by washcoating on the metal surface, and catalytic nanosized metal and/or metaloxide particles are deposited by means of a flame spray pyrolysis (FSP) method on the metal surface which has been coated with the metal oxide support.

In one embodiment, nanoparticles, e.g. nanopowder, of the metaloxide support, e.g. Al₂O₃ support, are formed by means of a flame spray pyrolysis (FSP) method. In one embodiment, catalytic nanosized metal particles and/or metaloxide particles, e.g. Co metaloxide particles, are formed by means of chemical vapour synthesis (CVS). In one embodiment, catalytic nanosized metal and/or metaloxide particles, Co metaloxide particles, are deposited on the surface of the nanoparticles of the metaloxide support. In one embodiment, the metal surface is coated with catalytic nanosized metal and/or metaloxide particles, e.g. Co oxide particles, which have been supported by the metaloxide support. In one embodiment, the metal surface is coated with catalytic nanosized metal and/or metaloxide particles by means of a flame spray pyrolysis (FSP) method.

In one embodiment, the metal surface is pretreated by means of heat treatment at 500-800° C., nanoparticles of the metaloxide support are formed by means of a flame spray pyrolysis (FSP) method, catalytic nanosized metal and/or metaloxide particles are formed by means of chemical vapour synthesis (CVS) and deposited on the surface of the nanoparticles of the metaloxide support, and the metal surface is coated with catalytic nanosized metal and/or metaloxide particles, which have been deposited on the nanoparticles of the metaloxide support.

In one embodiment, a specific holder is designed and is arranged to carry the metal object in connection with the flame spray pyrolysis (FSP). In one embodiment, distance of the holder and the flame is adjusted in connection with the flame spray pyrolysis (FSP). In one embodiment, distance between the metal surface of the metal object and the flame is adjusted in connection with the flame spray pyrolysis (FSP).

In one embodiment, deposition temperature is adjusted during the deposition. In one embodiment, deposition temperature is adjusted during the deposition of the catalytic nanosized metal and/or metaloxides particles on the metaloxide support. In one embodiment, deposition temperature is adjusted by means of distance between the metal object and the flame of FSP during the deposition. In one embodiment, deposition temperature is adjusted by means of cooling the deposit surface to enhance deposition by means of thermophoresis.

In one embodiment, a surface coverage can be adjusted by either changing a deposition temperature or increasing a deposition time.

The catalyst may be formed with different structures, in one embodiment with a monolith element. In one embodiment, the catalyst is used in catalytic reactors, in self-cleaning surfaces, in production of biomass derived chemicals, in production of transportation fuels, in FT-synthesis (Fischer-Tropsch synthesis), in reformers for fuel cell applications, in gas treatment units for syngas applications or in aqueous phase reformers for biorefineries.

In one embodiment, the method is used to form a catalytic nanocoating into reactors, such as catalytic reactors, reformers of fuel cell applications and aqueous phase reformers for biorefinery, and in processes, such as production of biomass derived chemicals, production of transportation fuels, FT-synthesis (Fischer-Tropsch synthesis) and gas treatment unit for syngas applications and production of self-cleaning surfaces, and their combinations.

A combination comprising a pretreatment of the metal surface and a coating of the metal surface with catalytically active metals is important for the invention. Thanks to the invention a catalytic nanocoating which is durable and has a high surface area can be produced on the metal surface. Thanks to the invention the catalytic nanocoating can be formed directly on the metal surface. This catalytic nanocoating can be easily applied for different nanocoatings. An advantage of this method compared to a method in which Co powder is manufactured and then metal plates are coated with the powder is that the metal and/or metaloxide particles do not have time to sinter and aggolomerate before they are deposited on the metaloxide support and the metal surface. Thus, in the invention, the primary particle size remains very small, preferably below about 10 nm. Additionally, the metal and/or metaloxide particles are homogeneously dispersed, on the metaloxide support and at high temperature they are also adhered on the surface.

The invention provides the advantage that catalysts with good quality can be achieved and metal loading in catalysts can be decreased. Thanks to the invention reactor throughput can be improved.

Further, the combination of the invention opens up possibilities to improve technical and economic feasibility in production processes of various biomass derived chemicals and transportation fuels.

The present invention provides an industrially applicable, simple and affordable way of producing catalytic nanocoatings. The method of the present invention is easy and simple to realize as a production process.

### LIST OF DRAWINGS

In the following section, the invention will be described with the aid of detailed exemplary embodiments, referring to the accompanying drawings wherein

FIG. 1 presents a flowchart illustration of a method according to one embodiment of the present invention,

FIG. 2 presents a flowchart illustration of a method according to one embodiment of the present invention,

FIG. 3 presents one embodiment of the flame spray pyrolysis, and

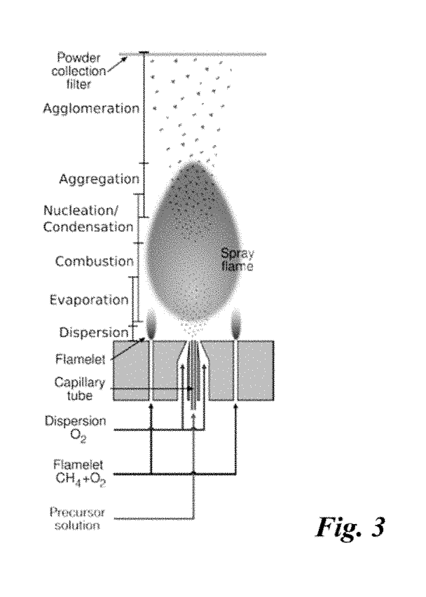

FIG. 4 shows product concentration in outlet gas as function of residence time.

### DETAILED DESCRIPTION OF THE INVENTION

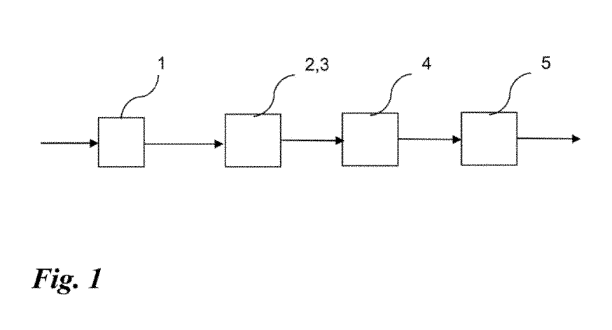

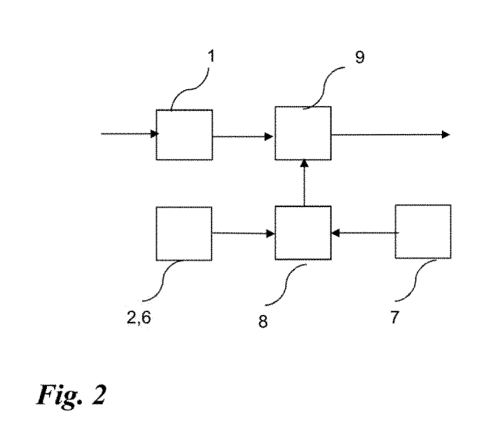

FIGS. 1 and 2 present the method according to the invention for forming a catalytic nanocoating.

### Example 1

In the method of FIG. 1 a catalytic nanocoating is formed on a metal surface.

The metal surface of the metal plate is pretreated (1) by means of heat treatment by oxidizing at 500-800° C. The metaloxide support, such as Al₂O₃ support, is formed (2) by washcoating (3) on the pretreated metal surface so that the metal surface is washcoated with metaloxide based slurry, such as Al₂O₃ based slurry, by spraying or dip-coating. The washcoated support is calcined (4) at about 400° C. on the metal surface. The catalytic nanosized metal and/or metaloxide particles, such as Co oxide particles, are deposited (5) by means of a flame spray pyrolysis (FSP) method on the metal surface which has been coated with the metaloxide support. The metaloxide nanoparticles are deposited above the flame on the metal oxide support.

The metal and/or metaloxide particles can be homogeneously dispersed on the metaloxide support, and at high temperature they are also well adhered on the surface.

### Example 2

In the method of FIG. 2 a catalytic nanocoating is formed on a metal surface.

The metal surface of the metal plate is pretreated (1) by means of heat treatment at 500-800° C. Nanoparticles of the metaloxide support, such as nanoparticles of Al₂O₃ support, are formed (2,6) by means of a flame spray pyrolysis (FSP) method. Catalytic nanosized metal and/or metaloxide particles are formed (7) by means of chemical vapour synthesis (CVS) and deposited (8) on the surface of the nanoparticles of the metaloxide support. The metal surface is coated (9) with catalytic nanosized metal and/or metaloxide particles, which have been deposited on the nanoparticles of the metaloxide support. The catalytic nanosized metal and/or metaloxide particles which have been supported by the metaloxide support are deposited on the metal surface.

The devices used in examples 1 and 2 and this invention are known per se, and therefore they are not described in any more detail in this context.

### Example 3

The metal surface of the metal plate was pretreated by means of heat treatment at 500-800 ° C.

The metaloxide (Al₂O₃) support was formed by washcoating on the pretreated metal surface so that the metal surface was washcoated with Al₂O₃ based slurry by spraying. The washcoated support was calcined, at about 400° C. on the metal surface. The catalytic nanosized. Co-oxide particles were deposited by means of a flame spray pyrolysis (FSP) method on the metal surface, which had been coated with the metaloxide support. The Co-oxide nanoparticles were deposited above the flame on the support. The Co-oxide particles were homogeneously dispensed on the metaloxide support, and at high temperature they were also well adhered on the surface.

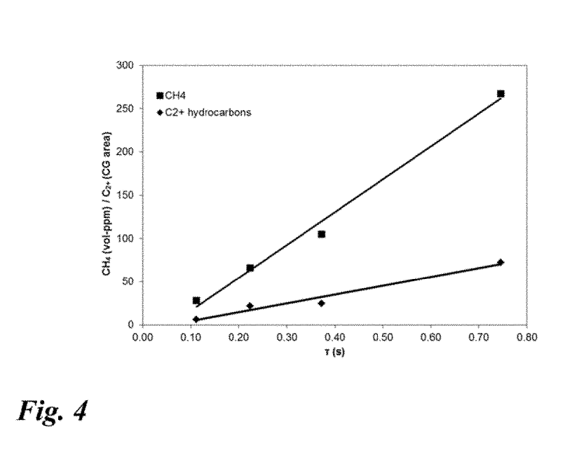

The catalyst was tested for Fischer-Tropsch reaction in a laboratory scale reactor at 230° C. and atmospheric pressure. The feed gas contained 33.3 vol % CO and 66.7 vol % H₂. The flow rate was varied from 0.15 to 1.00 lₙ/min. The measured product concentrations in outlet gas by gas chromatograph are depicted as function of residence time in FIG. 4. The catalyst produced methane and higher hydrocarbons. The activity of the catalyst increased steadily when the residence time was increased and there was no sign of the activity loss during the experiment.

The method according to the invention is suitable in different embodiments for forming different catalytic nanocoatings. The method according to the invention is suitable in different embodiments for forming different kinds of catalysts.

The invention is not limited merely to the examples referred to above; instead many variations are possible within the scope of the inventive idea defined by the claims.

1. A method for forming a catalytic nanocoating on a metal surface, wherein the method comprises
pretreating the metal surface by means of heat treatment at 500-800° C.,
forming a metaloxide support, and
depositing catalytic nanosized metal and/or metaloxide particles on the metaloxide support and coating the metal surface with catalytic nanosized metal and/or metaloxide particles.

2. The method according to claim 1, wherein the metal surface is heat-treated by oxidizing.

3. The method according to claim 1, wherein the metaloxide support is formed by washcoating on the metal surface, and catalytic nanosized metal and/or metaloxide particles are deposited by means of flame spray pyrolysis (FSP) method on the metal surface which has been coated with the metaloxide support.

4. The method according to claim 3, wherein the metal surface is washcoated with a metaloxide based slurry.

5. The method according to claim 3, wherein the washcoating is carried out by spraying or dip-coating.

6. The method according to claim 3, wherein the metaloxide support formed by washcoating is calcined at 400-800° C.

7. The method according to claim 1, wherein nanoparticles of the metaloxide support are formed by means of a flame spray pyrolysis (FSP) method, catalytic nanosized metal and/or metaloxide particles are formed by means of chemical vapour synthesis (CVS) and deposited on the surface of the nanoparticles of the metaloxide support, and the metal surface is coated with catalytic nanosized metal and/or metaloxide particles.

8. The method according to claim 1, wherein the metaloxide support comprises Al₂O₃, MgO, TiO₂, other metaloxide or their combination.

9. The method according to claim 1, wherein catalytic nanosized metal and/or metaloxide particles comprises metal selected from the group Co, Ni, Mo, Zr, Ti, Hf, noble metal, other suitable metal and their combinations.

10. The method according to claim 1, wherein a distance between the metal surface of the metal object and the flame is adjusted in connection with the flame spray pyrolysis (FSP).

11. A catalyst, wherein the catalyst comprises a catalytic nanocoating on the metal surface, and the catalytic nanocoating has been formed onto the metal surface by the method of claim 1.

12. A catalyst according to claim 11, wherein the catalyst is used in catalytic reactors, in self-cleaning surfaces, in production of biomass derived chemicals, in production of transportation fuels, in FT-synthesis, in reformers for fuel cell applications, in gas treatment units for syngas applications or in aqueous phase reformers for biorefineries.

13. A use of the method of claim 1, wherein the method is used to form a catalytic nanocoating in reactors, such as catalytic reactors reformers of fuel cell applications and aqueous phase reformers for biorefinery, and in processes, such as production of biomass derived chemicals, production of transportation fuels, FT-synthesis and gas treatment unit for syngas applications and production of self-cleaning surfaces, and their combinations.
